(19) United States
(12) Patent Application Publication
(10) Pub. No.: US 2026/0322316 A1
(43) Pub. Date: Oct. 15, 2026

(54) UNOBSTRUCTED SOLAR PANEL ASSEMBLY

(71) Applicant: SEG Solar Inc., Houston, TX (US)

(72) Inventors: Tao Zou, Changzhou City (CN); Jian Zhou, Taizhou City (CN); Jun Zhuge, Cypress, TX (US)

(73) Assignee: SEG Solar Inc., Houston, TX (US)

(21) Appl. No.: 19/467,183

(22) Filed: Feb. 2, 2026

Related U.S. Application Data
(60) Provisional application No. 63/755,003, filed on Feb. 6, 2025.

(51) Int. Cl. H02S 20/23

(52) U.S. Cl. CPC H02S 20/23

(57) ABSTRACT

A solar module has a photovoltaic panel having a first thickness and a frame structure for retaining the photovoltaic panel on at least two sides. The frame structure has an elongated body on each of the at least two sides, and the elongated body is defined by a substantially consistent cross section. The substantially consistent cross section has a substantially horizontal section for engaging a back surface of the photovoltaic panel, and a substantially vertical section extending from the substantially horizontal section in a substantially perpendicular direction for engaging a side surface of the photovoltaic panel, the substantially vertical section having a first height, and where the first height is smaller than the first thickness. Also provided is a solar module assembly including the frame structure.

### CROSS-REFERENCE TO RELATED APPLICATION

This application takes priority from U.S. Provisional Patent Application No. 63/755,003 filed Feb. 6, 2025, the contents of which are incorporated by reference herein in their entirety.

### FIELD OF THE INVENTION

The invention relates to framing and mounting assemblies for solar photovoltaic panels.

### BACKGROUND

At present, the mainstream design of photovoltaic module frames encloses an edge of a photovoltaic panel, or PV panel, on three sides. Accordingly, when installed, an edge of the PV panel is located within a channel formed by the three sides of the frame. This includes an “A-side,” or front side, which rests on a front surface of the PV panel and makes the frame higher than the PV panel, typically formed from laminated glass. The A-side thereby causes partial shading.

During long-term operation of the module, a large amount of dust and water stains may form on the surface, thereby causing local shadows. When large amounts of dust and water stains accumulate on the surface of solar panels, they create local shading, optical and thermal stress, which can trigger a wide range of electrical, thermal, optical, and reliability failures. Accordingly, when the dust and water stains cannot be cleaned and eliminated over a long period of time, the hot spot effect increases, and upon reaching a failure level, some cells of the module turn from power generation to power consumption. In severe cases, it will cause a fire or other PV panel failure, resulting in the scrapping of the entire solar cell module, and in some cases, causing the roof and other buildings to burn down.

In order to avoid this dust and stain accumulation problem, some designs remove the A-side of the frame.

FIG. 1 is an existing solar panel implementation showing an assembly 100 including a frame 110 and a pressure block 120 retaining a photovoltaic (PV) panel 130. In the assembly 100 shown, the frame 110 does not include a front lip, or A-side, which has been removed. Accordingly, the frame 110 has a back surface 140 for engaging a back surface 150 of the PV panel 130 and a side wall, or B side 160 for contacting the PV panel. In order to secure the PV panel 130 within the context of the assembly, the pressure block 120, or bracket, is used to compress the PV panel 130 into the frame 110, and the side wall 160 may have a geometry allowing use as a glue storage wall 165.

In order to provide a buffer between the PV panel 130 and the pressure block 120, a buffer gasket 170 may be utilized. Accordingly, a top portion 180 of the pressure block 120 compresses the buffer gasket 170 against the PV panel 130 in order to retain the PV panel 130 against the back surface 140 of the frame 110. The pressure block 120 may then be fixed to a bracket base 190 by way of a fastener 195, such as a bolt.

As shown in FIG. 1, when the PV panel 130 is located within the frame 110, the B side 160 of the frame 110 extends beyond a front surface of the PV panel 130. Accordingly, the buffer gasket 170 fills a gap between the front surface of the PV panel 130 and a front lip of the B side 160.

Accordingly, the frame A-side has been removed, but the frame 110 is still a certain size higher than the glass 130, as shown in FIG. 1. As a result, it is impossible to completely eliminate dust and water stains. A glue storage wall 165 is left on the inner side of the side wall 160 of the frame 110, or the B side 160. Such a geometry of the side wall 160 can cause the risk of the PV panel 130 breaking during framing. After the A-side is removed, the contact area between the frame 110 and the glass laminate 130 is reduced, and the bonding mainly relies on the back surface 140 of the frame 110, which reduces the overall bonding force and reduces the load-bearing capacity.

Traditional pressure blocks are mainly used during power station installation. Since the frame 110 has no A-side, the top portion 180 of the pressure block 120 is in direct contact with the glass 130, and a buffer gasket 170 needs to be added, which increases the cost. In addition, the pressure block 120 partially blocks the front of the module, affecting the appearance and creating an additional location in which debris can collect over time.

There is a need for a structure that optimizes and addresses some of the above concerns. Such a new frame design allows for improved aesthetics for the solar modules along with a structure that avoids debris accumulation while improving the manufacturing yield and load capacity.

### SUMMARY

In some embodiments, a solar module is provided including a photovoltaic panel having a first thickness and a frame structure for retaining the photovoltaic panel on at least two sides. The frame structure has an elongated body on each of the at least two sides, and the elongated body is defined by a substantially consistent cross section. The substantially consistent cross section has a substantially horizontal section for engaging a back surface of the photovoltaic panel, and a substantially vertical section extending from the substantially horizontal section in a substantially perpendicular direction for engaging a side surface of the photovoltaic panel, the substantially vertical section having a first height, and where the first height is smaller than the first thickness.

In some embodiments, the substantially horizontal section has at least one groove for retaining adhesive.

In some embodiments, the vertical section includes a plurality of protrusions, and a space between the protrusions retains adhesive for fixing the photovoltaic panel to the frame structure.

In some embodiments, the substantially consistent cross section includes a base section where the substantially horizontal section defines a top boundary of the base section, and where the frame structure further includes a foot for locating the frame structure at a mounting surface, and where the foot is spaced apart from the substantially horizontal section and defines a bottom boundary of the base section such that the base section supports the photovoltaic panel at the substantially horizontal section and spaces the photovoltaic panel apart from the mounting surface.

In some such embodiments, the substantially horizontal section has a length longer than a width of the base section, such that the top boundary of the base section is defined by only a portion of the substantially horizontal section.

In some embodiments having a base section, the base section is an internal hollow section.

In some embodiments having a base section, the base section includes a retention notch, where the retention notch is angled towards the foot, and where an internal surface of the retention notch forms an acute angle with an outside wall of the base section below the retention notch. In some such embodiments, the outside wall is an extension of the substantially vertical section.

In some embodiments, the frame structure includes the elongated body on four sides of the photovoltaic panel.

Also provided is a solar module assembly having a frame structure for retaining a photovoltaic panel on at least two sides. The frame structure includes an elongated body on each of the at least two sides, where the elongated body is defined by a substantially consistent cross section.

The substantially consistent cross section has a substantially horizontal section for engaging a back surface of the photovoltaic panel during use, and a substantially vertical section extending from the substantially horizontal section in a substantially perpendicular direction. The substantially vertical section has a first height.

The substantially consistent cross section also has an outside wall having a retention notch, where the retention notch is angled towards a bottom of the frame structure, and where an internal surface of the retention notch forms an acute angle with the outside wall below the retention notch.

In some embodiments, the substantially horizontal section includes grooves for retaining adhesive.

In some embodiments, the substantially vertical section includes a plurality of protrusions, and a space between the protrusions retains adhesive for fixing the photovoltaic panel to the frame structure.

In some embodiments, the substantially consistent cross section further includes a base section, the substantially horizontal section defines a top boundary of the base section, and the frame structure further includes a foot for locating the frame structure at a mounting surface, where the foot is spaced apart from the substantially horizontal section and defines a bottom boundary of the base section, and where the base section includes the outside wall of the substantially consistent cross section. In use, the base section supports the photovoltaic panel at the substantially horizontal section and spaces the photovoltaic panel apart from the surface.

In some such embodiments, the substantially horizontal section has a length longer than a width of the base section, such that the top boundary of the base section is defined by a portion of the substantially horizontal section.

In some embodiments utilizing a base section, the base section is an internal hollow section.

In some embodiments, the outside wall is an extension of the substantially vertical section.

In some embodiments, the solar module assembly includes at least one pressure block for retaining the frame structure relative to the mounting surface, where the pressure block includes a protrusion for mating with the retention notch.

In some such embodiments, the solar module assembly also includes a fastener for fastening the pressure block to the mounting surface.

In some embodiments, the solar module assembly includes the photovoltaic panel retained by the frame structure. In some such embodiments, the frame structure includes the elongated body on four sides of the photovoltaic panel.

### BRIEF DESCRIPTION OF THE DRAWINGS

FIG. 1 is an existing solar panel assembly implementation;

FIG. 2 is a solar panel assembly in accordance with this disclosure.

FIG. 3 is a perspective section view of the solar panel assembly of FIG. 2.

FIG. 4 is an elevation section view of the solar panel assembly of FIG. 2.

FIG. 5 is an elevation section view of the solar panel assembly of FIG. 2 with a central portion of a solar panel removed.

FIG. 6 is a detail elevation section view of the solar panel assembly of FIG. 2.

FIG. 7 is a detail elevation section view of a portion of FIGS. 6 and 6.

FIG. 8 is an elevation section view of the solar panel assembly of FIG. 2 with a pressure block.

FIG. 9 is a perspective view of multiple linked solar panel assemblies.

FIG. 10 is an elevation view of the multiple linked solar panel assemblies of FIG. 10.

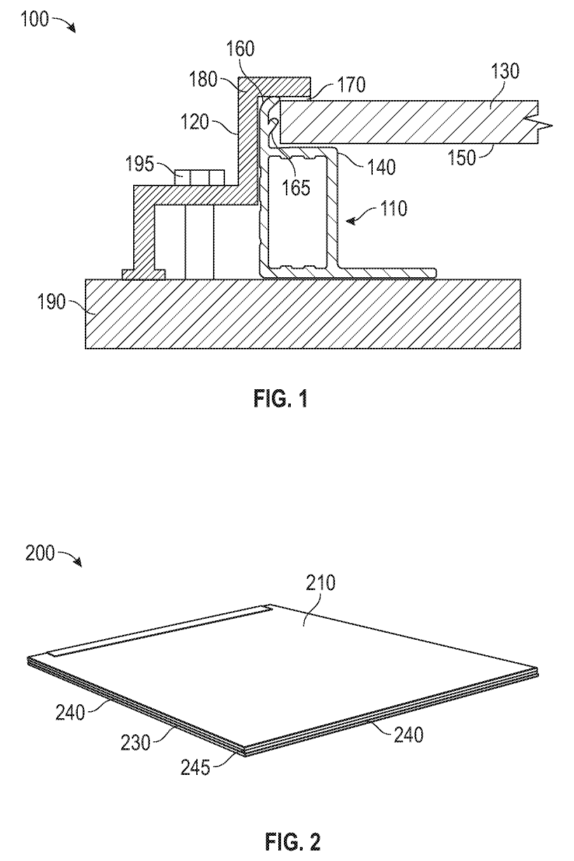

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

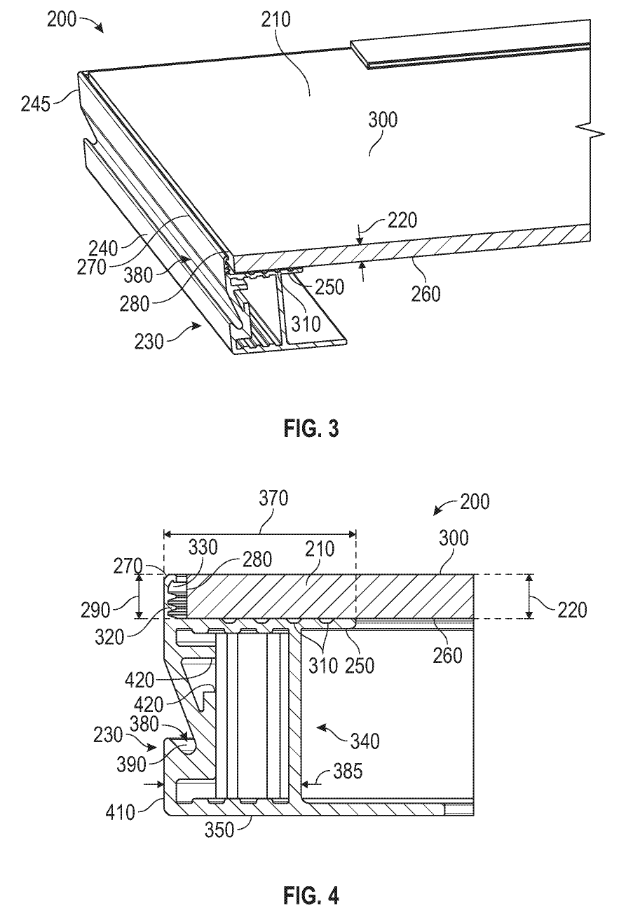

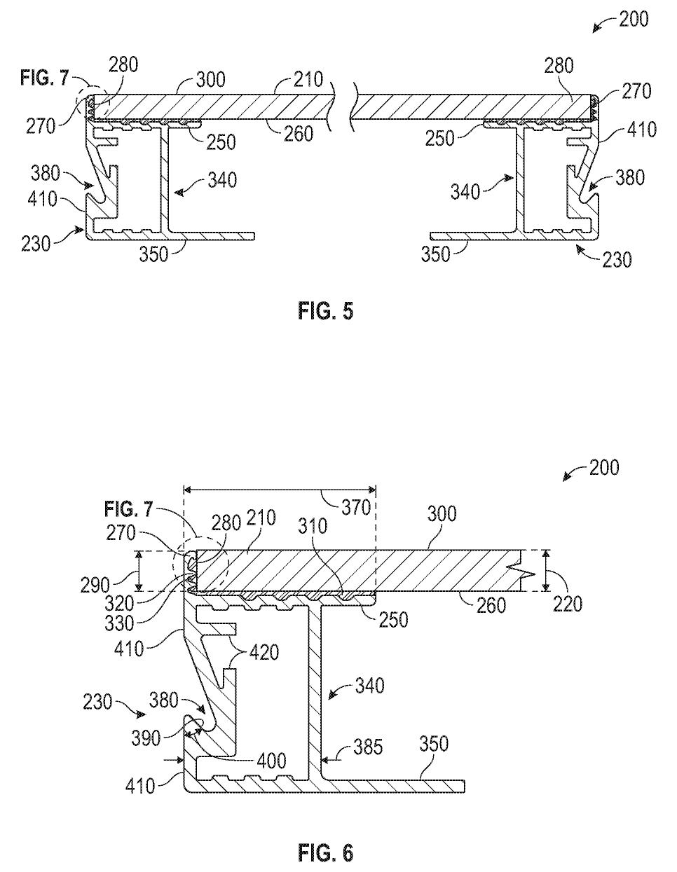

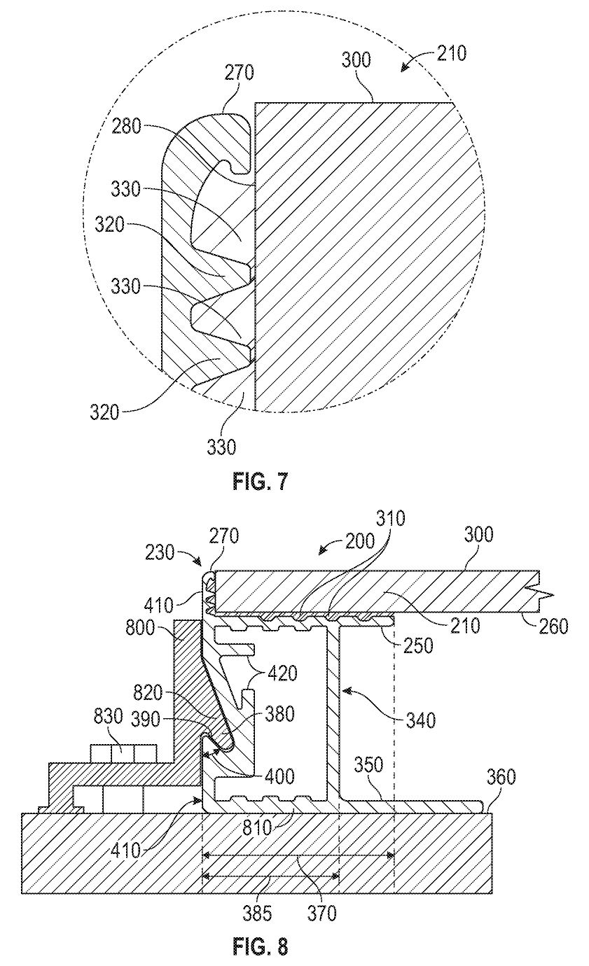

FIG. 2 is a solar panel assembly 200 in accordance with this disclosure. FIG. 3 is a perspective section view of the solar panel 200 assembly of FIG. 2. FIG. 4 is an elevation section view of the solar panel assembly 200 of FIG. 2. FIG. 5 is an elevation section view of the solar panel assembly 200 of FIG. 2 with a central portion of a solar panel 210 removed. FIG. 6 is a detail elevation section view of the solar panel assembly 200 of FIG. 2. FIG. 7 is a detail elevation section view of a portion of FIG. 6.

As shown, the solar panel assembly 200, or solar module, includes a PV panel 210 having a first thickness 220 and a frame structure 230 for retaining the PV panel 210 on at least two sides. As shown in FIG. 2, the frame structure 230 would typically retain the PV panel 210 on all four sides. The photovoltaic, or PV panel 210, is a panel used to produce electricity from sunlight, and typically comprise a number of solar cells embedded in or fixed between glass panels.

The frame structure 230 comprises an elongated body 240 on each side on which it retains the PV panel 210. Accordingly, where the frame structure 230 encloses and retains the PV panel 210 on all four sides, it would then comprise four elongated bodies 240 which could then meet at corners 245. Each elongated body 240 is defined by a substantially consistent cross section. However, it is understood that the cross section may vary as the elongated body 240 approaches the corner 245.

Accordingly, the elongated body 240 corresponds largely to a hypothetical extrusion of the substantially consistent cross section, shown in FIGS. 3-6 and 8. The cross section has a substantially horizontal section 250 for engaging a back surface 260 of the PV panel 210 and a substantially vertical section 270 extending from the substantially horizontal section 250 in a substantially perpendicular direction which then engages a side surface 280 of the PV panel 210.

The substantially vertical section 270 has a first height 290 smaller than the first thickness 220 corresponding to the thickness of the PV panel 210. Accordingly, when the PV panel 210 is positioned within the frame structure 230, the substantially vertical section 270 terminates before extending the entire thickness 220, or depth, of the PV panel 210. Typically, the substantially vertical section 270 would terminate approximately 1-2 mm short of the front surface 300 of the PV panel 210. Accordingly, a front surface 300 of the PV panel 210 is unobstructed by any shadows that may result from the substantially vertical section 270 or by dust or water which may be retained by the vertical section. Further, because the PV panel 210 is retained with no lip from the frame, the accumulation of rain, stains, and waste can be avoided, which can greatly reduce the risk of hot spots.

It is understood that the term horizontal in reference to the substantially horizontal section 250 and the term vertical in reference to the substantially vertical section 270 are intended to be in the context of the frame structure 230. However, it will be understood that the frame structure may be mounted at various angles or may be fixed to an angled or movable surface. Accordingly, while the substantially horizontal section 250 and the substantially vertical section 270 are substantially perpendicular to each other, they may not correspond to horizontal and vertical structures in a global coordinate system.

As shown, the substantially horizontal section 250 may include at least one groove 310 for retaining an adhesive. Because the solar panel assembly 200 does not include a frame with a front “A-side” that would retain the PV panel 210 and obstruct the edges of the panel, the frame structure 230 must be able to retain the PV panel without such a front surface. Accordingly, the use of adhesive is more important, and the groove 310 in the substantially horizontal section 250 may then improve bonding between the section and the back surface 260 of the PV panel 210. Where a silicone adhesive is used, the groove 310 substantially increase the bonding area and therefore the bonding strength between the frame structure 230 and the silicone.

The substantially vertical section 270 may similarly be structured in order to increase the ability of the frame structure 230 to bond with the PV panel 210. Accordingly, the substantially vertical section 270 may consist of a plurality of protrusions 320. Spaces 330 between the protrusions 320 may then retain adhesive for fixing the PV panel 210 to the frame structure 230. Such an adhesive may be, for example, a silicone adhesive. As shown, a small gap may be provided between the surfaces of the frame structure 230 and the PV panel 210, such that those gaps 330 may be filled with adhesive. The use of such protrusions 320 and gaps 330 further reduces the risk of PV panels 210 breaking during framing and improves a glue overflow effect, thereby improving manufacturing yield. The drawings are provided schematically and not to scale, but in some embodiments, a 1.5mm gap may be provided between the side surface 280 of the PV panel 210 and the substantially vertical section 270.

The protrusions 320 thereby define multiple contact points between the inner side of the substantially vertical section 270 and the side surface 280 of the PV panel 210, thereby replacing existing structures of glue storage walls. The multiple contact points and the adhesive retained therein improve the quality of the contact between the components, thereby reducing the risk of a PV panel breaking during framing.

The substantially consistent cross section of the elongated body 240 may further include a base section 340. The substantially horizontal section 250 may then define a top boundary of the base section 340, and the frame structure 230 may further include a foot 350 for locating the frame structure at a mounting surface 360. The foot 350 is then spaced apart from the substantially horizontal section 250 and defines a bottom boundary of the base section 340. Accordingly, the base section 340 supports the PV panel 210 at the substantially horizontal section 250 and spaces the PV panel apart from the mounting surface 360.

As discussed below in reference to FIG. 8, the mounting surface 360 may be a surface on which the solar panel assembly 200 is installed, or it may be a portion of the solar panel assembly 200 to which the frame structure 230 is fixed. For example, the mounting surface 360 may be a portion of a bracket structure which is, itself, mounted on an external structure.

In the embodiment shown, the substantially horizontal section 250 has a length 370 longer than a width 385 of the base section 340. Accordingly, the top boundary of the base section 340 is defined by only a portion of the substantially horizontal section 250. As such, the substantially horizontal section 250 may be provided with a longer length 370, thereby providing an increased grooved 310 bonding surface for mating with the back surface 260 of the PV panel 210. Accordingly, a groove 310 may be incorporated into a portion of the length 370 of the substantially horizontal section 250 that extends beyond the base section 240. This increased surface area of the substantially horizontal section 250 thereby increases the bonding area between the frame structure 230 and the adhesive, such as silicone, used to mate the frame structure with the PV panel 210, thereby increasing overall load capacity which may, in turn, increase the service life of the PV panels 210.

The base section 340 may be, or may include, an internal hollow section so as to decrease weight while increasing rigidity of the frame structure 230.

The base section 340 may further include a retention notch 380 for allowing the frame structure 230 to be retained by an external component, such as a bracket or pressure block. The retention notch 380 is angled towards the foot 350, and an internal surface 390 of the retention notch then forms an acute angle 400 with an outside wall 410 of the base section 340 below the retention notch. In some embodiments, the outside wall 410 may be an extension of the substantially vertical section 270 of the frame structure 230 such that the otherwise continuous outside wall 410 is interrupted by the retention notch 380.

As shown, the substantially consistent cross section of the elongated body 240 may include additional extensions 420 within a hollow base section 340. Such additional extensions may be incorporated so as to increase the rigidity or otherwise improve the performance of the frame structure 230 taken as a whole. Accordingly, because the frame structure 230 is intended to be retained in position by way of the retention notch 380, internal extensions 420 may be incorporated so as to increase the structural integrity of that notch.

FIG. 8 is an elevation section view of the solar panel assembly 200 of FIG. 2 with a pressure block 800. Accordingly, the frame structure 230 may comprise at least two elongated bodies 240 so as to retain a PV panel 210 on at least two sides. As discussed above, the frame structure 230 may include four such elongated bodies 240 so as to fully enclose such a PV panel on four sides. As noted above, the elongated body 240 is typically defined by a substantially consistent cross section having a substantially horizontal section 250 and a substantially vertical section 270 extending from the substantially horizontal section in a substantially perpendicular direction. Additional details of the substantially horizontal 250 and substantially vertical 270 sections of the frame structure 230 may be similar to those discussed above with respect to FIG. 2.

Accordingly, the substantially horizontal section 250 may be provided with at least one groove 310 for retaining adhesive and the substantially vertical section may consist of a plurality of protrusions 320, and where spaces 330 between the protrusions retain adhesive for fixing a PV panel 210 to the frame structure 230.

The frame structure 230 may further comprise an outside wall 410 having a retention notch 380 for allowing the frame structure 230 to be retained by an external component, such as the bracket or pressure block 800. The retention notch 380 is angled towards a bottom 810 of the frame structure 230, and an internal surface 390 of the retention notch then forms an acute angle 400 with the outside wall 410 below the retention notch. As discussed above, in some embodiments, the outside wall 410 may be an extension of the substantially vertical section 270 of the frame structure 230 such that the otherwise continuous outside wall 410 is interrupted by the retention notch 380.

As noted above, the substantially consistent cross section of the frame structure 230 may include a base section 340. The substantially horizontal section 250 may then define a top boundary of the base section 340, and the frame structure 230 may further include a foot 350 for locating the frame structure at a mounting surface 360. The foot 350 is then spaced apart from the substantially horizontal section 250 and defines a bottom boundary of the base section 340. Accordingly, when a PV panel 210 is fixed within the frame structure 230, the base section 340 supports the PV panel at the substantially horizontal section 250 and spaces the PV panel apart from the mounting surface 360. The foot 350 typically corresponds to the bottom 810 of the frame structure 230 indicated above.

The base section 340 may then comprise the outside wall 410 of the substantially consistent cross section. In some embodiments, the outside wall 410 may be an extension of the substantially vertical section 270 of the frame structure 230 such that the otherwise continuous outside wall 410 is interrupted by the retention notch 380.

In the embodiment shown, the substantially horizontal section 250 has a length 370 longer than a width 385 of the base section 340. Accordingly, the top boundary of the base section 340 is defined by only a portion of the substantially horizontal section 250. As such, the substantially horizontal section 250 may be provided with a longer length 370, thereby providing an increased grooved 310 bonding surface for mating with the back surface 260 of the PV panel 210. Accordingly, a groove 310 may be incorporated into a portion of the length 370 of the substantially horizontal section 250 that extends beyond the base section 340.

The base section 340 may be or may include an internal hollow section so as to decrease weight while increasing rigidity of the frame structure 230. As discussed above, additional extensions 420 may be provided within the hollow base section 340 so as to increase rigidity or otherwise improve the performance of the frame structure 230.

As noted above, the solar panel assembly 200 may further include at least one pressure block 800, or bracket, for retaining the frame structure 230 relative to the mounting surface 360. The mounting surface 360 may be a surface on which the solar panel assembly 200 is installed, or it may be a portion of the solar panel assembly 200 to which the frame structure 230 is fixed. Accordingly, the mounting surface 360 may be a base component of the pressure block 800 which is, itself, mounted on an external structure. Alternatively, the mounting surface 360 may be a portion of an external structure utilized for locating the solar panel assembly 200.

The pressure block 800 comprises a protrusion 820 for mating with the retention notch 380. The pressure block 800 then compresses the frame structure 230 against the mounting surface 360 by way of the retention notch 380. A fastener 830 may then be provided for fastening the pressure block 800 to the mounting surface 360.

During use, in order to mount the frame structure 230 to a mounting surface 360, multiple pressure blocks 800 may be provided. For example, 2 or more pressure blocks 800 may be utilized on each side of the frame structure 230. Further, each pressure block 800 may be localized, and may therefore not extend for a length of the elongated section 240. For example, each pressure block may be 50-80mm wide.

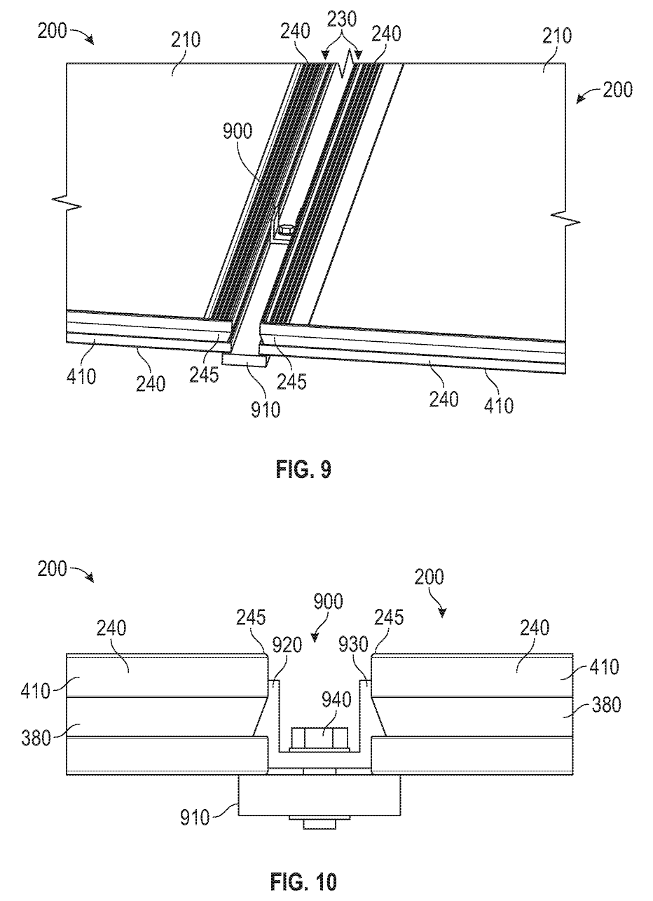

FIG. 9 is a perspective view of multiple linked solar panel assemblies 200. FIG. 10 is an elevation view of the multiple linked solar panel assemblies 200 of FIG. 10. As shown, in some embodiments, multiple solar panel assemblies 200 may be linked by way of pressure blocks 900 and mounting surfaces 910. Accordingly, a single pressure block 900 may be provided with two distinct protrusions 920, 930, each of which mates with a retention notch 380 of a corresponding frame structure 230. A fastener 940 may then mate the pressure block to the mounting surface 910. All components may be provided as portions of a system utilized to link multiple iterations of the solar panel assemblies 200 described above in a single installation.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, t he foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A solar module comprising:
a photovoltaic panel having a first thickness; and
a frame structure for retaining the photovoltaic panel on at least two sides,
wherein the frame structure comprises an elongated body on each of the at least two sides, wherein the elongated body is defined by a substantially consistent cross section, the substantially consistent cross section having:
a substantially horizontal section for engaging a back surface of the photovoltaic panel, and
a substantially vertical section extending from the substantially horizontal section in a substantially perpendicular direction for engaging a side surface of the photovoltaic panel, the substantially vertical section having a first height,
wherein the first height is smaller than the first thickness.

2. The solar module of claim 1, wherein the substantially horizontal section comprises at least one groove for retaining adhesive.

3. The solar module of claim 1, wherein the vertical section comprises a plurality of protrusions, and wherein a space between the protrusions retains adhesive for fixing the photovoltaic panel to the frame structure.

4. The solar module of claim 1, wherein the substantially consistent cross section further comprises a base section,
wherein the substantially horizontal section defines a top boundary of the base section, and
wherein the frame structure further comprises a foot for locating the frame structure at a mounting surface, wherein the foot is spaced apart from the substantially horizontal section and defines a bottom boundary of the base section,
such that the base section supports the photovoltaic panel at the substantially horizontal section and spaces the photovoltaic panel apart from the mounting surface.

5. The solar module of claim 4, wherein the substantially horizontal section has a length longer than a width of the base section, such that the top boundary of the base section is defined by only a portion of the substantially horizontal section.

6. The solar module of claim 4, wherein the base section is an internal hollow section.

7. The solar module of claim 4, wherein the base section further comprises a retention notch, wherein the retention notch is angled towards the foot, and wherein an internal surface of the retention notch forms an acute angle with an outside wall of the base section below the retention notch.

8. The solar module of claim 7, wherein the outside wall is an extension of the substantially vertical section.

9. The solar module of claim 1, wherein the frame structure comprises the elongated body on four sides of the photovoltaic panel.

10. A solar module assembly comprising:
a frame structure for retaining a photovoltaic panel on at least two sides,
wherein the frame structure comprises an elongated body on each of the at least two sides, wherein the elongated body is defined by a substantially consistent cross section, the substantially consistent cross section having:
a substantially horizontal section for engaging a back surface of the photovoltaic panel during use, and
a substantially vertical section extending from the substantially horizontal section in a substantially perpendicular direction, the substantially vertical section having a first height
an outside wall having a retention notch, wherein the retention notch is angled towards a bottom of the frame structure, and wherein an internal surface of the retention notch forms an acute angle with the outside wall below the retention notch.

11. The solar module assembly of claim 10, wherein the substantially horizontal section comprises grooves for retaining adhesive.

12. The solar module assembly of claim 10, wherein the substantially vertical section comprises a plurality of protrusions, and wherein a space between the protrusions retains adhesive for fixing the photovoltaic panel to the frame structure.

13. The solar module assembly of claim 10, wherein the substantially consistent cross section further comprises a base section,
wherein the substantially horizontal section defines a top boundary of the base section, and
wherein the frame structure further comprises a foot for locating the frame structure at a mounting surface, wherein the foot is spaced apart from the substantially horizontal section and defines a bottom boundary of the base section, and
wherein the base section comprises the outside wall of the substantially consistent cross section;
such that in use, the base section supports the photovoltaic panel at the substantially horizontal section and spaces the photovoltaic panel apart from the surface.

14. The solar module assembly of claim 13, wherein the substantially horizontal section has a length longer than a width of the base section, such that the top boundary of the base section is defined by a portion of the substantially horizontal section.

15. The solar module assembly of claim 13, wherein the base section is an internal hollow section.

16. The solar module assembly of claim 10, wherein the outside wall is an extension of the substantially vertical section.

17. The solar module assembly of claim 10 further comprising at least one pressure block for retaining the frame structure relative to the mounting surface, wherein the at least one pressure block comprises a protrusion for mating with the retention notch.

18. The solar module assembly of claim 17 further comprising a fastener for fastening the at least one pressure block to the mounting surface.

19. The solar module assembly of claim 10 further comprising the photovoltaic panel retained by the frame structure.

20. The solar module assembly of claim 19 wherein the frame structure comprises the elongated body on four sides of the photovoltaic panel.
